(19) United States
(12) Patent Application Publication
(10) Pub. No.: US 2023/0187925 A1
(43) Pub. Date: Jun. 15, 2023

(54) ELECTRICAL PROTECTION SYSTEMS AND METHODS HAVING IMPROVED SELECTIVITY

(71) Applicant: Schneider Electric Industries SAS, Rueil Malmaison (FR)

(72) Inventor: Daniel Gonzalez, Domene (FR)

(73) Assignee: Schneider Electric Industries SAS, Rueil Malmaison (FR)

(21) Appl. No.: 18/075,528

(22) Filed: Dec. 6, 2022

(30) Foreign Application Priority Data
Dec. 14, 2021 (FR) 2113496

(51) Int. Cl. H02H 3/26; H02H 3/08

(52) U.S. Cl. CPC H02H 3/265; H02H 3/083

(57) ABSTRACT

An electrical protection method for detecting an electrical fault in an electrical installation includes: measuring electrical variables by way of an auxiliary protection device, the electrical variables being associated with phase conductors; automatically analysing the measured electrical variables in order to identify a condition representative of a short circuit between phase conductors; detecting an electrical fault, such as a short circuit between the three electrical phases associated with the phase conductors without any neutral conductor involved, based on the measured electrical variables; triggering the opening of a switching device of the auxiliary protection device when an electrical fault is identified in order to disconnect one of the phase conductors, the switching device being connected to one of the phase conductors.

### TECHNICAL FIELD

The present invention relates to electrical protection systems and methods. The invention more generally relates to the field of electrical protection in electricity distribution installations.

### BACKGROUND

It has long been known for electrical protection devices, such as circuit breakers, to be used that allow the power supply to an electrical load or an electrical installation to be interrupted if an electrical fault, such as a short-circuit, occurs.

Protection devices also allow, as a function of selectivity rules defined for the scale of the electrical installation, the part of the electrical installation that is the source of the electrical fault to be isolated in order to allow the rest of the electrical installation to function normally.

For example, the protection devices are coordinated in a hierarchical manner in the installation, so that the protection devices located closest to the electrical loads and/or electrical sources are set so that, when an electrical fault occurs, they trigger more quickly than protection devices located further upstream, in order to isolate only the electrical load or electrical source causing the fault and to prevent an upstream protection device from triggering and interrupting the electrical supply to an entire section of the electrical installation.

Such protection devices generally include a trigger, the function of which is to detect an electrical fault, using electromechanical and/or electronic detection means, in order to detect when the amplitude of the electric current becomes too high.

Such triggers have been satisfactory for a long time. However, recent technological developments, such as, for example, those associated with the development of renewable energies, require the development of protection devices that meet new requirements.

Indeed, it is increasingly common for local or domestic electrical installations to be powered, for example, by photovoltaic electrical sources and/or by electricity storage devices capable of occasionally operating as generators.

Such electrical sources are generally based on switching power converters operated by power switches, such as power semi-conductor components. However, due to the presence of these power switches, these electrical sources behave differently from conventional generators in the event of an electrical fault.

In particular, fault currents, in particular short-circuit currents, have a much lower amplitude than in conventional installations, due to the inherent technical features of the semi-conductor components that are used.

In conventional installations only powered by the public electricity grid (mains), the short-circuit currents that are usually encountered can have high amplitudes, sometimes reaching up to several kiloamperes (kA), since their amplitude is only limited by the impedance of the upstream transformer and/or by the impedance of the distribution cables. By contrast, in installations comprising one or more switching converters, the amplitudes of the fault currents are lower, for example, ten times lower, or worse.

Thus, in modern installations comprising one or more switching power converters, it is more difficult to detect certain electrical faults.

Therefore, there is a risk that, in the event of a fault, a protection device connected downstream close to an electrical source or load may not react quickly enough or at all with respect to the selectivity rules programmed for this device, taking into account the actual current supplied by the semi-conductor converter, and that, as a result, the source itself may protect itself by stopping the supply of power, thereby interrupting the parts of the electrical installation that were powered by this source.

This results in a poor quality of service for the user.

It is these disadvantages that the invention more specifically intends to overcome by proposing electrical protection systems and methods in an electrical installation comprising a switching power converter.

### SUMMARY

To this end, one aspect of the invention relates to an electrical protection method for detecting an electrical fault in an electrical installation, said electrical installation comprising at least one electrical source based on a switching power converter and a protection system, said electrical source being connected to the rest of the three-phase electrical installation by phase conductors, the protection system comprising at least one protection device and an auxiliary protection device associated with the electrical source, the method comprising steps involving:
measuring electrical variables by way of the auxiliary protection device, the electrical variables being associated with the phase conductors;
automatically analyzing the measured electrical variables, by means of an electronic control device of the auxiliary protection device, in order to identify a condition representative of a short-circuit between said phase conductors;
detecting an electrical fault, such as a short-circuit between the three electrical phases associated with said phase conductors without any neutral conductor involved, based on the measured electrical variables;
triggering the opening of a switching device of the auxiliary protection device when an electrical fault is identified by the electronic control device, in order to disconnect one of said phase conductors, said switching device being connected to one of said phase conductors between said electrical source and the rest of the electrical installation.

According to advantageous but non-essential aspects_{;} such a method can incorporate one or more of the following features_{;} taken alone or according to any technically permissible combination:
the electrical variables are alternating electric voltages measured on the phase conductors connecting said electrical source to the rest of the electrical installation, the measurement of said electric voltages being carried out by voltage sensors of the auxiliary protection device;
following the opening of the switching device by way of the auxiliary protection device, the electric current circulates between said electrical source and the rest of the electrical installation in said phase conductors that have not been opened, with this current leading to the triggering of at least one of the protection devices;
automatically analyzing the measured electrical variables comprises a comparison of at least some of the measured values with a predefined reference threshold or with a reference waveform, and wherein an electrical fault such as a short-circuit between the three electrical phases is detected if the measured values are considered to be low enough and/or similar;
the protection devices are configured so as to have predefined selectivity for the scale of the electrical installation.

According to another aspect, the invention relates to an electrical protection system for an electrical installation comprising at least one electrical source based on a switching power converter, the protection system comprising at least one electrical protection device and an auxiliary protection device (20) associated with the electrical source, the auxiliary protection device being configured for:
measuring electrical variables by way of the auxiliary protection device, the electrical variables being associated with the phase conductors;
automatically analyzing the measured electrical variables, by means of an electronic control device of the auxiliary protection device, in order to identify a condition representative of a short-circuit between said phase conductors;
detecting an electrical fault, such as a short-circuit between the three electrical phases associated with said phase conductors, based on the measured electrical variables;
triggering the opening of a switching device of the auxiliary protection device when an electrical fault is identified by the electronic control device, in order to disconnect one of said phase conductors, said switching device being connected to one of said phase conductors between said electrical source and the rest of the electrical installation.

According to advantageous but non-essential aspects, such a method can incorporate one or more of the following features, taken alone or according to any technically permissible combination:
the switching device comprises an electromechanical switch, or a semi-conductor switch or a hybrid switch;
the auxiliary protection device is integrated in a protection device associated with said electrical source;
the auxiliary protection device is a separate device from a protection device associated with said electrical source.

According to another aspect, the invention relates to an electrical installation comprising an electrical source based on a switching power converter and a protection system.

### BRIEF DESCRIPTION OF THE DRAWINGS

The invention will be better understood, and other advantages thereof will become more apparent in light of the following description, which is provided solely by way of an example and with reference to the accompanying drawings, in which:

FIG. 1 is a block diagram of an example of an electrical installation comprising an electrical protection system according to the invention;

FIG. 2 shows more details of part of the electrical protection system of FIG. 1;

FIG. 3 is a block diagram of a control device of the electrical installation of FIG. 1;

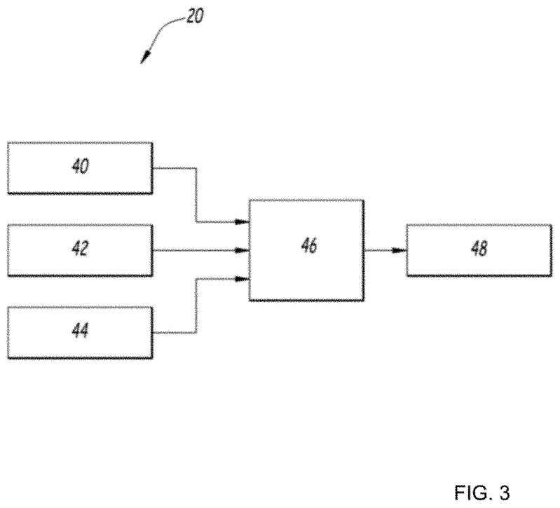

FIG. 4 shows an example of the evolution of an electric current over time during the operation of the electrical protection device of FIG. 1;

FIG. 5 is a block diagram showing an example of a method according to the invention.

### DETAILED DESCRIPTION

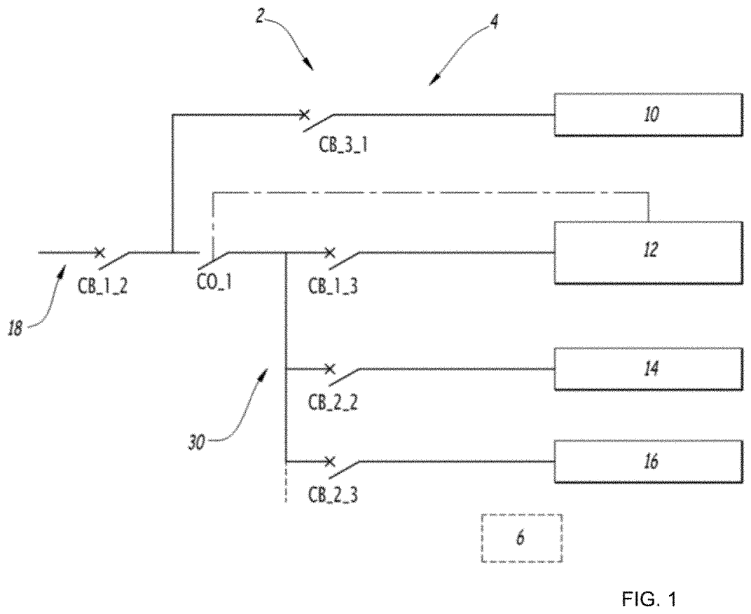

FIG. 1 shows an example of an electrical installation 2, such as an electricity distribution installation in a building or in a group of buildings.

The electrical installation 2 comprises at least one electrical grid, electrical loads, an electrical source comprising a switching power converter including one or more power switches, such as power semi-conductor components. Hereafter, this electrical source is considered to be based on semi-conductors. The installation also comprises a component for separating the electrical installation from the electrical grid, protection devices and electrical conductors, allowing the current produced by the one or more electrical source(s) to be distributed to the one or more electrical load(s).

The electrical installation 2 in this case is configured to distribute an alternating current (AC).

Preferably, the electrical installation 2 is configured to distribute a three-phase current, without a neutral line. The number of electrical conductors used to connect each source or each load is therefore adapted accordingly (for example, three separate electrical conductors respectively associated with the three phases).

Preferably, at least one of the electrical sources of the electrical installation 2 comprises or is based on a switching power converter, such as an inverter, with the power converter comprising power semi-conductor components, such as transistors.

The installation 2 also comprises an electrical protection system 4 configured to protect the installation 2 against electrical faults, and more specifically against short-circuits.

The protection system 4 comprises, for example, one or more electrical switching devices, such as contactors, and a plurality of electrical protection devices, such as circuit breakers.

The protection devices each comprise a trigger capable of measuring the electric current and of triggering the opening of the corresponding protection device when an electrical fault, such as a short-circuit, is detected.

The triggers comprise, for example, sensors capable of measuring an alternating current, preferably for each electrical phase, and can be associated with the various electrical protection devices.

The protection system 4 also comprises an auxiliary protection device 6, the role of which will be described in more detail hereafter.

The auxiliary protection device 6 is preferably connected in order to protect an electrical source (or to a reversible electrical load capable of operating as an electrical source) comprising or being associated with a switching power converter.

In the example shown in FIG. 1, the installation 2 comprises a first electrical load 10, an electricity storage device 12, second electrical loads 14 and 16, and a point of connection to a conventional electrical source, such as an electricity distribution grid 18 (also called mains).

The electricity storage device 12, which comprises, for example, at least one electrochemical battery (or any other type of energy storage), can alternatively function as an electrical load (when it is in the process of storing or holding energy) or as an electrical source (when it is providing the energy for powering the installation 2). In other words, the storage device 12 can be considered to be a reversible electrical load.

The electricity storage device 12 is, for example, a battery or a set of batteries in a fixed electricity storage installation (or any other type of energy storage such as, for example, an inertial unit). It also can be an electric vehicle connected to a charging terminal connected to the installation 2.

In some installations, a distinction optionally can be made between electrical loads, called critical loads, which where possible should not be interrupted, and ordinary electrical loads, called non-critical loads, for which an interruption in the power supply can be tolerated to some extent.

For example, the first electrical load 10 is a non-critical load and the second electrical loads 14 and 16 are critical electrical loads, with this example not being limiting.

The critical loads 14 and 16 are connected, for example, so that they can be easily powered by the electricity storage device 12 when the source 18 is unavailable.

The sources 12 and 18 are connected to a main distributor 30, which in turn is connected to the electrical loads 10, 14 and 16.

For example, the point of connection to the electrical grid 18 is connected to the distributor 30 by means of an electrical protection device, such as a circuit breaker, denoted CB_1_2, and a switching device CO_1, such as a contactor, which in this example can be controlled by the electricity storage device 12, for example, in order to disconnect the electrical grid 20 when the electricity storage device 12 provides the installation 2 with enough electricity.

The electricity storage device 12 is connected to the distributor 30 by means of an electrical protection device, such as a circuit breaker, denoted CB_1_3.

The first electrical load 10 is connected to the distributor 30 by means of an electrical protection device, such as a circuit breaker, denoted CB_3_1.

The second electrical loads 14 and 16 are connected to the distributor 30 by means of electrical protection devices, such as circuit breakers, respectively denoted CB_2_2 and CB_2_3.

As an alternative embodiment, the installation 2 could be constructed differently, for example, with different loads and/or with different electrical sources and/or could have a different number of protection or switching devices and/or could have a different layout.

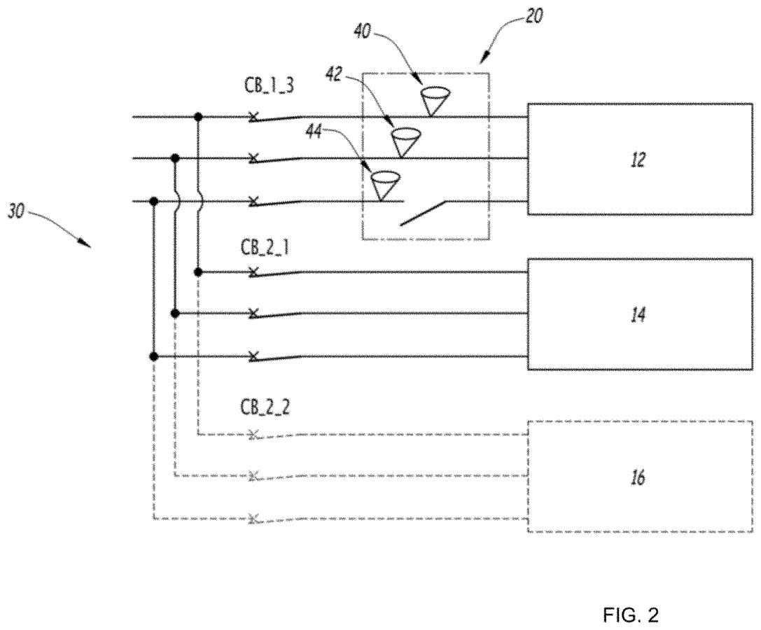

FIG. 2 schematically shows an example of the auxiliary protection device 6, in this case associated with the electricity storage device 12 and using reference sign 20 in this case.

In this example, the electricity storage device 12 is connected to the rest of the three-phase installation 2, via three phase conductors.

The following example is described with reference to the electricity storage device 12, but as an alternative embodiment the auxiliary protection device 20 can be used on any electrical device of the installation 2 acting as or likely to act as a voltage source, with this electrical device comprising or being associated with a switching power converter, comprising semi-conductor components, for example. For example, this could be a photovoltaic source, comprising one or more solar panels connected to such a switching power converter.

As an alternative embodiment, the protection system 4 could also comprise a plurality of auxiliary protection devices 20 in the event that the installation 2 comprises a plurality of electrical sources comprising or being based on a switching power converter.

As shown in FIG. 2, the auxiliary protection device 20 comprises voltage sensors 40, 42 and 44, an electronic control device 46 and a switching device 48 associated with one of said electrical phases.

In alternative embodiments, the auxiliary protection device 20 could, in alternative embodiments not described hereafter, also use one or more current measurement(s) to assist in the decision made by way of the auxiliary protection device 20, either instead of the voltage sensors 40, 42 and 44 or in addition to the voltage sensors 40, 42 and 44.

As shown in FIG. 2, each of the voltage sensors 40, 42 and 44 is configured to measure the electric voltage per phase or between phases powering the critical loads of the installation.

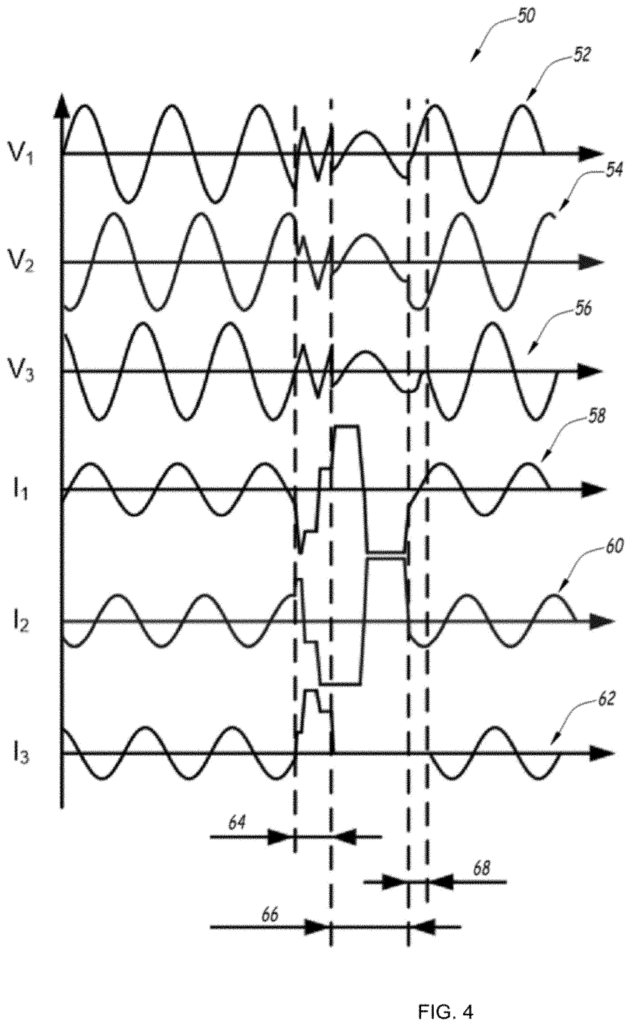

For example, each of the voltage sensors 40, 42 and 44 is connected, for example, to two of the three phase conductors (associated with the first, second and third electrical phases) that connect the electricity storage device 12 to the rest of the installation 2 in order to measure, for example, the three phase-to-phase voltages distributed by the three phase conductors (respectively denoted V1, V2 and V3 in FIG. 4).

The switching device 48 comprises a controllable switch mounted on one of the phase conductors, with this switch being able to switch between an electrically open state and an electrically closed state. For example, the switching device 48 is an electromechanical switch, or a semi-conductor switch, or a hybrid switch (using both electromechanical and semi-conductor technologies), or any suitable device.

For example, the electronic control device 46 comprises a processor, such as a programmable microcontroller or microprocessor. In an alternative embodiment, the control device can be produced using analogue, wired or mixed technology. The processor is coupled to a computer memory, or to a computer-readable data storage medium, comprising executable instructions and/or a software code provided to implement an electrical fault detection method as described hereafter when these instructions are executed by the processor.

As an alternative embodiment, the electronic control device 46 can comprise a signal processing processor (DSP), or a programmable logic controller (PLC), or a reprogrammable logic component (FPGA), or a specialized integrated circuit (ASIC), or any equivalent element (or system).

The electronic control device 46 comprises inputs for receiving measurement signals originating from the sensors 40, 42 and 44. The electronic control device 46 also comprises an output connected to the switching device 48 for sending control orders to the switching device 48.

The auxiliary protection device 20 is programmed to intervene in the event of a short-circuit affecting the electrical phases (without affecting a possible neutral line).

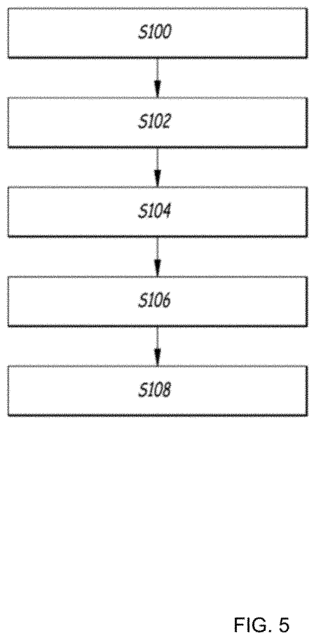

In many embodiments, as shown with reference to FIGS. 4 and 5, the auxiliary protection device 20 is more specifically configured to implement a method comprising steps of:
measuring (step S100), by the voltage sensors 40, 42, 44 of the auxiliary protection device 20, the alternating electric voltages V1, V2 and V3 distributed by the phase conductors connecting said electrical source 12 to the rest of the electrical installation;
automatically analyzing (step S102), by the electronic control device 46, the values of the voltages measured by the voltage sensors 40, 42, 44, in order to identify a condition representative of an electrical fault, in particular a condition representative of a three-phase short-circuit without neutral;
detecting (step S104) an electrical fault of the three-phase short-circuit type without neutral, based on the measured electric voltages;
triggering (step S106) the opening of the switching device 48 of the auxiliary protection device 20 when an electrical fault is identified by the electronic control device 46.

This opening results in the disconnection of one of said phase conductors (the third conductor associated with the third phase, for example), with said switching device 48 being connected to one of said phase conductors between said electrical source 12 and the rest of the electrical installation.

Preferably, following the opening of the switching device 48 by way of the auxiliary protection device 20 during step S106, the electric current then circulates between said electric source 12 and the rest of the electrical installation only in said phase conductors corresponding to the phases that have not been disconnected from the source 12 (in this case, in the first phase and the second phase, since the third phase was disconnected in step S106).

This electric current, which then only circulates on two phases instead of three phases, results in the triggering (step S108) of one of the protection devices CB_2_2, CB_2_3.

Indeed, the RMS value of the resulting current is higher, since the electric current now only has two phases instead of three for circulating, to the extent that it exceeds the protection threshold of the corresponding protection device.

In other words, in step S106, a short-circuit present on three phases is converted into a short-circuit present on two phases in order to increase the RMS value of the current that circulates on the remaining phases and thus force the triggering of at least one protection device.

In practice, the protection devices (CB_1_2, CB_1_3, CB_3_1, CB_2_2, CB_2_3) are configured so as to have predefined selectivity for the scale of the electrical installation 2.

In the example shown, the fault is considered to occur at the electrical load 14. The corresponding protection device is then triggered, in order to disconnect the electrical load 14. This triggering is caused by the protection device itself, when its trigger detects an abnormal increase of the electric current on the first phase and the second phase corresponding to the phase conductors that were not disconnected in step S106.

According to one embodiment, step S102 involves automatically analyzing at least the measured voltage values in order to identify at least one feature representative of a fault condition. In step 3104, an electrical fault, such as a short-circuit between the three electrical phases, is considered to be detected if such a condition is identified.

Preferably, the shape of the measured voltages V1, V2 and V3 is analyzed in order to determine the phase shift between the measured voltages V1, V2, V3, and in particular in order to detect whether the voltages are in phase. Indeed, if the short-circuit relates to the three phases, then the corresponding electric voltages are no longer phase shifted, whereas they are phase shifted during normal operation. The fault condition is therefore identified when the phase shift is zero.

In alternative embodiments, detecting a fault, in particular a short-circuit type fault, could be at least partly based on another criterion, for example, the value of the measured voltages, but also the shape of the electric currents I1, I2 and I3. As will be seen with reference to FIG. 4, when a fault such as an interphase short-circuit is present, the electric currents I1, I2 and I3 could be measured instead of the voltages V1, V2 and V3 in order to identify the specific shape of the currents in the event of a three-phase short-circuit (such as the stepped shape during the sequence 64 described hereafter with reference to FIG. 4). The sensors 40, 42 and 44 would then be adapted accordingly, for example, to be replaced by current sensors, or supplemented by current sensors.

In general, in other embodiments, the method is modified such that the measurement of voltages in step S100 is replaced by the measurement of one or more electrical variables associated with the phase conductors (such as the voltage, the current, the phase, and many others), with the analysis and detection (steps S102 and S104) then being carried out based on these measurements of electrical variables rather than from the voltage measurements alone.

The fault condition would then be modified accordingly. For example, the step (S102) for automatically analyzing the measured electrical variables could comprise, depending on the nature of the measured variables, a comparison of at least some of the measured values with a predefined reference threshold or with a reference waveform. The electrical fault, such as a short-circuit between the three electrical phases, would be considered to be detected (S104) if the measured values are considered to be low enough and/or similar (i.e., they have a similar waveform, optionally to the nearest offset value, with this offset value being due to the line impedance, which may not be the same for each of the phase conductors).

In many embodiments, the method can be repeated over time, for example, at least for steps S102 and S104, which can be repeated continuously or periodically or at predefined intervals.

As an alternative embodiment, the steps could be executed in a different order. Some steps could be omitted. The described example does not preclude that, in other embodiments, other steps may be implemented in conjunction and/or sequentially with the described steps. In some embodiments, the auxiliary protection device 20 is integrated with a protection device associated with said electrical source 12, for example, the device CB_1_3. Thus, the auxiliary protection device 20 can reuse elements of the protection device, such as sensors and/or the electronic control device and/or the device for switching one of the phases. As an alternative embodiment, the auxiliary protection device 20 either can be a separate device from the protection device (CB_1_3) associated with said electrical source 12, or can be a separate device but using resources from the protection device via an appropriate connection.

FIG. 4 shows the operation of the installation in further detail when implementing the method.

In this example, the graph 50 shows the evolution of the electric voltages V1, V2, V3 (curves 52, 54 and 56, respectively) and of the electric currents I1, I2 and I3 (curves 58, 60 and 62, respectively) shown on the ordinate, according to an arbitrary scale, as a function of time (denoted t, on the abscissa, according to an arbitrary scale) for each of the electrical phases of the installation, on electrical equipment of the installation 2 that is the source of an electrical fault (for example, the electrical load 14 is the source of an electrical fault).

The first phase, the second phase and the third phase are respectively associated with the first, second and third electric voltages V1, V2 and V3. The first phase, the second phase and the third phase are respectively associated with first, second and third electric currents I1, I2 and I3. As shown in FIG. 4, initially the electric current has, for example, a periodic and even sinusoidal shape. The components I1, I2 and I3 of each of the phases, respectively shown by the curves 58, 60 and 62, have sinusoidal waveforms, that are phase shifted in relation to each other.

When an electrical fault occurs, such as a short-circuit between the first phase and the second phase, the auxiliary protection device 20 quickly detects the fault (for example, during the first operating sequence identified by reference 64 in FIG. 4). During the first operating sequence 64, the waveform of the currents and voltages begins to change. In the second operating sequence 66, the waveform of the currents and voltages is temporarily stabilized.

In the example shown, the electric currents I1, I2 and I3 each have an irregular shape by assuming values defined in steps, generally between two equal but opposite sign saturation values. For example, the steps correspond to intermediate values corresponding to one third or two thirds of the saturation value. This behaviour is explained by the fact that, without a neutral line, the sum of the electric currents I1, I2 and I3 is zero at each instant.

Subsequently, the auxiliary protection device 20 opens the switching device 48 in order to interrupt the circulation of the electric current by disconnecting the corresponding phase conductor (for example, during the second operating sequence identified by reference 66 in FIG. 4), preferably at the source 12.

In this example, the third phase is opened by the switching device 48. In practice, the switching device 48 is associated with a single-phase conductor.

In practice, in the event that several power converter sources are located in the same installation, then, depending on the arrangement of the installation, there would be either at least one switching device for all the sources, or one switching device for each source, or a combination of switching devices suitable for the layout of the installation.

Following the opening of the switching device 48 and the disconnection of said electrical phase, the current significantly increases on the first phase and the second phase, for which the current can still circulate from the source 12, as shown in FIG. 4 from the second vertical dashed line (currents I₁ and I₃ on the first phase and the second phase).

At the same time, the current I₃ circulating on the third phase is interrupted and then assumes a zero value.

In response to this increase on the first phase and the second phase (in this example), one of the electrical protection devices of the installation 2, for example, the protection device C_2_2 associated with the equipment 14 that in this example is the source of the electrical fault, triggers and switches to the open state, which disconnects the equipment that is the source of the electrical fault and eliminates the fault current (the short-circuit current in the considered example).

This is shown in FIG. 4 from the third vertical dashed line (marking the end of the second operating sequence 66 and the beginning of the third operating sequence identified by reference 68), where the voltage components of each of the phases, distributed at the input of each critical load, differ from each other in order to return to their normal waveforms.

Advantageously, once the electrical fault (for example, the short-circuit) has been eliminated due to the triggering of the protection device, then the auxiliary protection device 20 controls the reconnection of the electrical phase that was previously disconnected in step S106, for example, by controlling the switching device 48.

For example, the auxiliary protection device 20 detects that the electrical fault has been eliminated by identifying that the fault condition has disappeared. For example, the auxiliary protection device 20 detects that the voltages V1, V2 and V3 associated with the three electrical phases are once again phase shifted. In the example shown in FIG. 4, this corresponds to the behaviour of the system after the end of the third sequence 68, where the voltages and the currents of each phase each return to a normal waveform.

By virtue of the invention, the auxiliary protection device 20 allows an electrical fault, in particular a short-circuit between the three electrical phases, to be detected more quickly and more reliably than an installation only equipped with electrical protection devices provided with conventional triggers.

Indeed, in installations comprising an electrical source comprising or being based on a switching power converter, the fault current has a lower amplitude than with conventional electrical sources (such as a public electricity grid or a generator set), to the extent that the conventional triggers may not detect such a fault.

The auxiliary protection device 20 provides an improvement to this limitation.

By disconnecting one of the phases when it detects such an electrical fault, the auxiliary protection device 20 creates an increase in the RMS current on the remaining phases, which makes the occurrence of a fault more visible. As the amplitude of the fault current is higher than that of the “actual” fault, the fault thus amplified is quickly detected by the trigger of the protection device connected directly upstream of the equipment causing the fault.

Thus, the protection system 4 enables a quick response to the occurrence of an electrical fault, in particular a short-circuit between the three electrical phases, whilst complying with the selectivity rules defined for the scale of the installation 2.

This thus prevents the electrical source 12 from being completely interrupted, or even the entire electrical installation 2 from being stopped, because the protection device connected directly upstream of the equipment causing the fault would not have been sensitive enough or fast enough to detect the electrical fault.

By virtue of the protection system 4, it is possible to select, in such an electrical installation 2 and for the electrical protection devices (other than the auxiliary protection device 20), higher current ratings, while having the assurance that an electrical fault, such as a short-circuit between the three electrical phases, will be detected by virtue of the auxiliary protection device 20.

Evaluations over several ranges of protection devices have shown that the current rating can be increased by at least 10%, and up to 27% for some ranges of devices, all other things being equal.

The embodiments and the alternative embodiments contemplated above can be combined in order to create new embodiments.

1. An electrical protection method for detecting an electrical fault in an electrical installation, said electrical installation comprising at least one electrical source based on a switching power converter and a protection system, said electrical source being connected to the rest of the three-phase electrical installation by phase conductors, the protection system comprising at least one protection device and an auxiliary protection device associated with the electrical source, the method comprising:
measuring electrical variables by way of the auxiliary protection device, the electrical variables being associated with the phase conductors;
automatically analyzing the measured electrical variables, by means of an electronic control device of the auxiliary protection device, in order to identify a condition representative of a short-circuit between said phase conductors;
detecting an electrical fault, such as a short-circuit between the three electrical phases associated with said phase conductors without any neutral conductor involved, based on the measured electrical variables; and
triggering the opening of a switching device of the auxiliary protection device when an electrical fault is identified by the electronic control device, in order to disconnect one of said phase conductors, said switching device being connected to one of said phase conductors between said electrical source and the rest of the electrical installation.

2. The electrical protection method according to claim 1, wherein the electrical variables are alternating electric voltages measured on the phase conductors connecting said electrical source to the rest of the electrical installation, the measurement of said electric voltages being carried out by voltage sensors of the auxiliary protection device.

3. The electrical protection method according to claim 1, wherein, following the opening of the switching device by way of the auxiliary protection device, the electric current circulates between said electrical source and the rest of the electrical installation in said phase conductors that have not been opened, with this current leading to the triggering of at least one of the protection devices.

4. The electrical protection method according to claim 1, wherein automatically analyzing the measured electrical variables comprises a comparison of at least some of the measured values with a predefined reference threshold or with a reference waveform, and wherein an electrical fault such as a short-circuit between the three electrical phases is detected if the measured values are considered to be low enough and/or similar.

5. The electrical protection method according to claim 1, wherein the protection devices are configured so as to have predefined selectivity for the scale of the electrical installation.

6. An electrical protection system for an electrical installation comprising at least one electrical source based on a switching power converter, the protection system comprising at least one electrical protection device and an auxiliary protection device associated with the electrical source, the auxiliary protection device being configured for:
measuring electrical variables by way of the auxiliary protection device, the electrical variables being associated with the phase conductors;
automatically analyzing the measured electrical variables, by means of an electronic control device of the auxiliary protection device, in order to identify a condition representative of a short-circuit between said phase conductors;
detecting an electrical fault, such as a short-circuit between the three electrical phases associated with said phase conductors, based on the measured electrical variables; and
triggering the opening of a switching device of the auxiliary protection device when an electrical fault is identified by the electronic control device, in order to disconnect one of said phase conductors, said switching device being connected to one of said phase conductors between said electrical source and the rest of the electrical installation.

7. The electrical protection system according to claim 6, wherein the switching device comprises an electromechanical switch, or a semi-conductor switch or a hybrid switch.

8. The electrical protection system according to claims 6, wherein the auxiliary protection device is integrated in a protection device associated with said electrical source.

9. The electrical protection system according to claim 6, wherein the auxiliary protection device is a separate device from a protection device associated with said electrical source.

10. An electrical installation comprising an electrical source based on a switching power converter and the electrical protection system according to claim 6.
